(19) United States
(12) Patent Application Publication
(10) Pub. No.: US 2008/0098131 A1
(43) Pub. Date: Apr. 24, 2008

(54) Playback device and computer program

(75) Inventor: Yoshikazu Onishi, Daito-shi (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd., Daito-shi (JP)

(21) Appl. No.: 11/902,868

(22) Filed: Sep. 26, 2007

(30) Foreign Application Priority Data
Oct. 24, 2006 (JP) 2006-289181

(51) Int. Cl. G06F 13/38

(52) U.S. Cl. 710/7

(57) ABSTRACT

A playback device includes: a USB interface; an information creation section for creating, based on operation in an operation section, information indicating playback sequence for files stored in an external storage device connected to the USB interface; a storage section for storing the created information into the external storage device connected to the USB interface; and a playback section for, based on information stored in an external storage device connected to the USB interface and indicating the playback sequence for the files stored in the external storage device, sequentially playing back the files.

This application is based on Japanese Patent Application No. 2006-289181 filed on Oct. 24, 2006, the contents of which are hereby incorporated by reference.

### BACKGROUND OF THE INVENTION

1. Field of the Invention

The present invention relates to a playback device having a USB interface.

2. Description of Related Art

Conventionally, a playback device has been developed to which a USB memory is attachable and which is capable of playing back a file stored in the USB memory (see JP-A-2005-72799 for an example of such a playback device).

Moreover, a so-called playback device with programmed playback capabilities has been conventionally developed which can play back musical pieces recorded on a CD or a MD in sequence set by the user. Developed as such a playback device is the one capable of storing into the main body thereof the sequence of musical pieces set by the user.

Thus, it is possible to combine together the playback devices described above to develop a playback device capable of performing program playback on files stored in a USB memory and storing into the main body thereof file playback sequence set by the user. With such a playback device, once the user sets file playback sequence, programmed playback can be achieved without subsequently requiring resetting operation.

However, with the playback device described above, to perform programmed playback with a USB memory attached to a playback device different from the playback device storing the file playback sequence in the main body thereof, since this playback device does not store the file playback sequence, the user is required to reset the playback sequence. This brings about a problem of low convenience.

### SUMMARY OF THE INVENTION

It is an object of the present invention to provide a highly convenient playback device and computer program capable of performing programmed playback in any playback device by only one setting operation without subsequently requiring resetting operation.

To achieve the object described above, a playback device according to one aspect of the present invention includes: a USB interface; an information creation section for creating, based on operation in an operation section, information indicating playback sequence for files stored in an external storage device connected to the USB interface; and a storage section for storing the created information into the external storage device connected to the USB interface.

To achieve the object described above, a playback device according to another aspect of the invention includes a USB interface; and a playback section for, based on information stored in an external storage device connected to the USB interface and indicating play back sequence for files stored in the external storage device, sequentially playing back the files.

According to such configuration, just one setting operation subsequently permits, in any playback device, programmed playback without requiring resetting operation, which improves convenience.

To achieve the object described above, a computer program according to still another aspect of the invention includes a computer program code for causing a computer having an operation section and a USB interface to execute the steps of: creating, based on operation in the operation section, information indicating playback sequence for files stored in an external storage device connected to the USB interface; and storing the created information into the external storage device connected to the USB interface.

### BRIEF DESCRIPTION OF THE DRAWINGS

FIG. 1 is a block diagram of a USB interface loading type DVD player according to the present invention;

FIG. 2 is a flowchart of operation of programmed playback performed by the USB interface loading type DVD player according to the invention;

FIG. 3 is a diagram showing an example of a program screen;

FIG. 4 is a flowchart for creating program setting information;

FIG. 5 is a diagram showing an example of a program screen;

FIG. 6 is a schematic configuration diagram of a personal computer;

FIG. 7 is a flowchart for operation of storing program setting information into a USB memory in the personal computer; and

FIG. 8 is a diagram showing an example of a program screen.

### DETAILED DESCRIPTION OF THE PREFERRED EMBODIMENTS

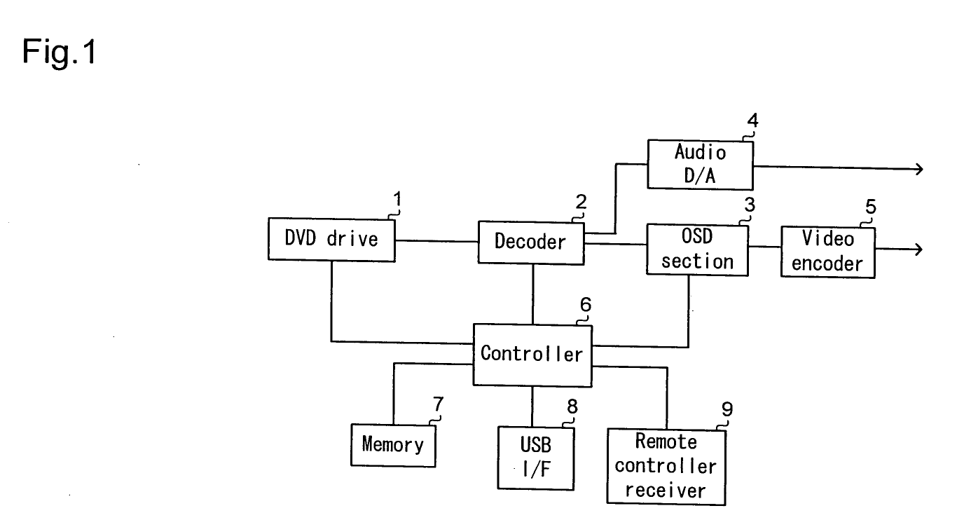

Embodiments of the present invention will be described below with reference to the accompanying drawings. FIG. 1 shows a block diagram of a USB interface loading type DVD player according to the invention.

The USB interface loading type DVD player according to the invention includes: a DVD drive 1, a decoder 2, an OSD section 3, an audio DA converter 4, a video encoder 5, a controller 6, a memory 7, a USB interface 8, and a remote controller receiver 9.

The DVD drive I retrieves video-audio information from a disc and outputs it to the decoder 2. The decoder 2 extends the video-audio information inputted from the DVD drive 1, and outputs a digital audio signal to the audio DA converter 4, and outputs a digital image signal to the OSD section 3. The audio DA converter 4 converts the digital audio signal into an analog audio signal and outputs it to an external speaker (not shown). The OSD section 3, in response to instructions given from the controller 6, generates a graphic character signal, synthesizes it with the digital image signal from the decoder 2 to thereby generate a synthetic signal, and outputs the synthetic signal to the video encoder 5. In addition, the OSD section 3 also outputs a graphic character signal to the video encoder 5 without synthesizing it. The video encoder 5 converts the synthetic signal and graphic character signal from the OSD section 3 into video signals, and outputs them to an external display device (not shown). The USB interface 8 is an interface to which a USB memory, not shown, can be attached. The decoder 2 extends a file retrieved by the controller 6 from the USB memory via the USB interface 8, and outputs a digital audio signal to the audio DA converter 4 and outputs a digital image signal to the OSD section 3. The remote controller receiver 9 receives an infrared signal from a remote controller, not shown, and outputs a code signal to the controller 6.

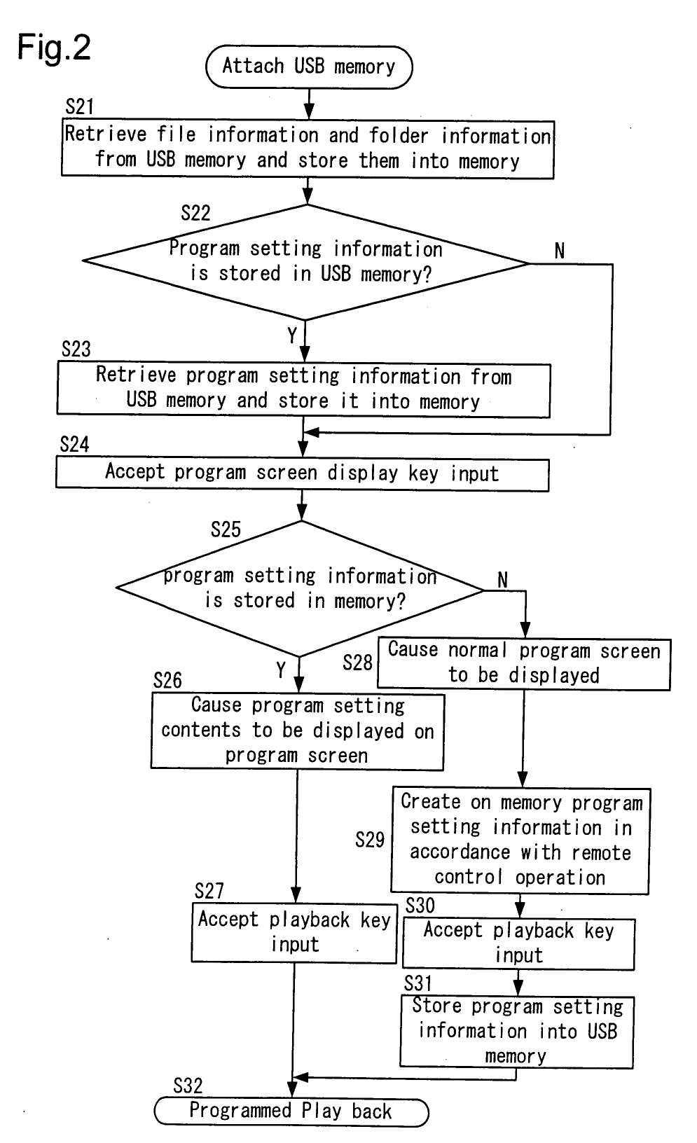

Operation of programmed playback performed in the USB interface loading type DVD player according to the invention with the configuration described above will be described below, following a flowchart shown in FIG. 2.

Upon attachment of a USB memory previously storing files, file information, and folder information but not storing program setting information to the USB interface 8, in step S21, the controller 6 retrieves the file information and the folder information from the USB memory via the USB interface 8 and stores them into the memory 7. The file information includes file position information, file name information, address information, and size information. The folder information includes folder position information and folder name information.

Then in step S22, the controller 6 reads the USB memory via the USB interface 8 and determines whether or not the USB memory stores program setting information to be described later. Here, the program setting information has not yet been stored in the USB memory (N in step S22); therefore, the operation proceeds to step S24.

In step S24, the controller 6 becomes ready for accepting key input, and when a program screen display key is inputted on the remote controller, the controller 6 receives a corresponding code signal from the remote controller receiver 9, and the operation proceeds to step S25.

In step S25, the controller 6 determines whether or not the memory 7 stores program setting information. Here, the memory 7 stores no program setting information (N in step S25); therefore, the operation proceeds to step S28.

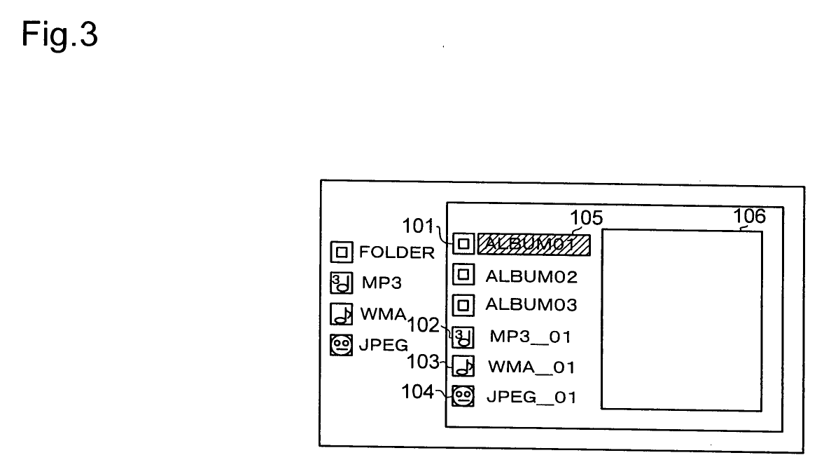

In step S28, the controller 6, based on the file information and the folder information stored in the memory 7, gives the OSD section 3 instructions for generating a graphic character signal, and the display device displays a normal program screen as shown in FIG. 3. Here, a folder name of a folder located immediately below a root folder is displayed with a mark 101 provided at the head of this folder name, a file name of an MP3 file located immediately below the root folder is displayed with a mark 102 provided at the head of this file name, a file name of a WMA file located immediately below the root folder is displayed with a mark 103 provided at the head of this file name, and a file name of a JPEG file located immediately below the root folder is displayed with a mark 104 provided at the head of this file name. In addition, a highlight 105 and a selected file display region 106 are additionally displayed. On this screen, the user can set file playback sequence.

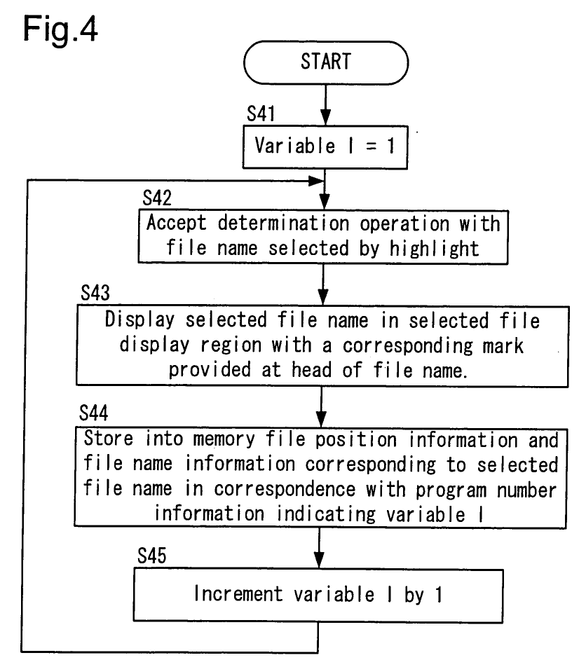

Then in step S29, the operation transits to operation shown in FIG. 4.

In step S41, the controller 6 substitutes 1 for a variable I.

Here, the highlight 105 can be moved by remote control, and a file name can be selected by the highlight 105. When a DETERMINE key is inputted on the remote controller under the condition that a folder name of a folder located immediately below the root folder is selected by the highlight 105, file and folder names of a file and folder located immediately below the folder with the selected folder name are displayed, and also here, a file name can be selected by the highlight 105. Similarly, a file name of a file located immediately below a folder in any hierarchy can be selected by the highlight 105.

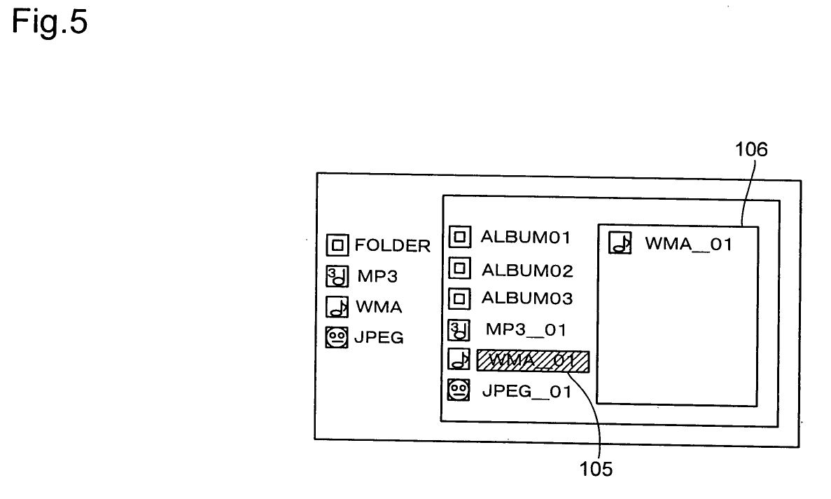

In step S42, the DETERMINE key is inputted on the remote controller under the condition that the file name is selected by the highlight 105 as described above, and the controller 6 receives a corresponding code signal, and then the operation proceeds to step S43. In step S43, the controller 6 gives the OSD section 3 instructions for generating a graphic character signal, and the file name selected by the highlight 105 is displayed on the selected file display region 106 with a corresponding mark provided at the head of this file name. FIG. 5 shows a screen in a case where the file name “WMA_{—}01” is selected by the highlight 105 and the DETERMINE key is inputted in FIG. 3.

Then in step S44, the controller 6 stores the file position information and file name information corresponding to the file name selected by the highlight 105 into the memory 7 in correspondence with program number information indicating the variable I.

Subsequently, in step S45, the controller 6 increments the variable I by 1, and thereafter the same operation is repeated every time a file name is selected and determined in step S42.

Then when step S45 has been completed, a PLAYBACK key is inputted on the remote controller and the controller 6 receives a corresponding code signal from the remote controller receiver 9 (step S30 of FIG. 2), and then in step S31, the controller 6 stores the program number information, file position information, and file name information stored in the memory 7 through the operation shown in FIG. 4, as program setting information, into the USB memory via the USB interface 8.

Subsequently, in step S32, the controller 6 sequentially retrieves files, in an ascending order of numbers indicated by the program number information stored in the memory 7, from addresses in the USB memory indicated by the address information stored in the memory 7 corresponding to the file position information and file name information corresponding to the program number information, whereby the files are sequentially played back.

Next, upon attachment of a USB memory storing the program setting information as described above to the USB interface 8, file information and folder information are retrieved from the USB memory and then stored into the memory 7 in step S21, and then the controller 6 determines whether or not the USB memory stores the program setting information in step S22. Here, the USB memory stores the program setting information (Y in step S22); therefore, the operation proceeds to step S23.

In step S23, the controller 6 retrieves the program setting information from the USB memory via the USB interface 8, and then stores it into the memory 7.

Then in step S24, the controller 6 becomes ready for accepting key input, and when a PROGRAM SCREEN DISPLAY key is inputted on the remote controller, the controller 6 receives a corresponding code signal from the remote controller receiver 9, and then the operation proceeds to step S25.

In step S25, the controller 6 determines whether or not the memory 7 stores program setting information. Here, the memory 7 stores the program setting information (Y in step S25); therefore, the operation proceeds to step S26.

In step S26, the controller 6, based on the file information, folder information, and program setting information stored in the memory 7, gives the OSD section 3 instructions for generating a graphic character signal, and the display device displays a program screen. Here, in addition to normal display contents provided in step S28 described above, corresponding file names are displayed on the selected file display region 106 in an ascending order of numbers indicated by the program number information, with corresponding marks provided at the heads of these file names. That is, the setting contents for the file playback sequence in step S29 described above are displayed.

Then in step S27, the PLAYBACK key is inputted on the remote controller and the controller 6 receives a corresponding code signal from the remote controller receiver 9, and then in step S32, the controller 6 sequentially retrieves files, in an ascending order of numbers indicated by the program number information stored in the memory 7, from addresses in the USB memory indicated by the address information stored in the memory 7 corresponding to the file position information and file name information corresponding to the program number information, whereby the files are sequentially played back.

With the USB interface loading type DVD player according to the invention as described above, once the user sets playback sequence for files stored in the USB memory, the files can be subsequently played back in the set playback sequence without requiring resetting operation in both of the USB interface loading type DVD player used for this setting and another USB interface loading type DVD player according to the invention, which is highly convenient.

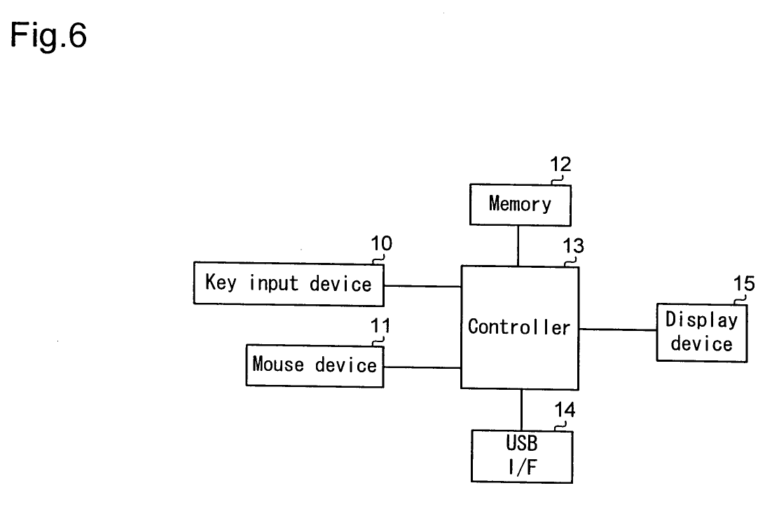

Moreover, the storage of the program setting information into the USB memory can be achieved by a personal computer as shown below. FIG. 6 shows a schematic configuration diagram of the personal computer. The personal computer shown in FIG. 6 includes: a key input device 10, a mouse device 11, a memory 12, a controller 13, a USB interface 14, and a display device 15.

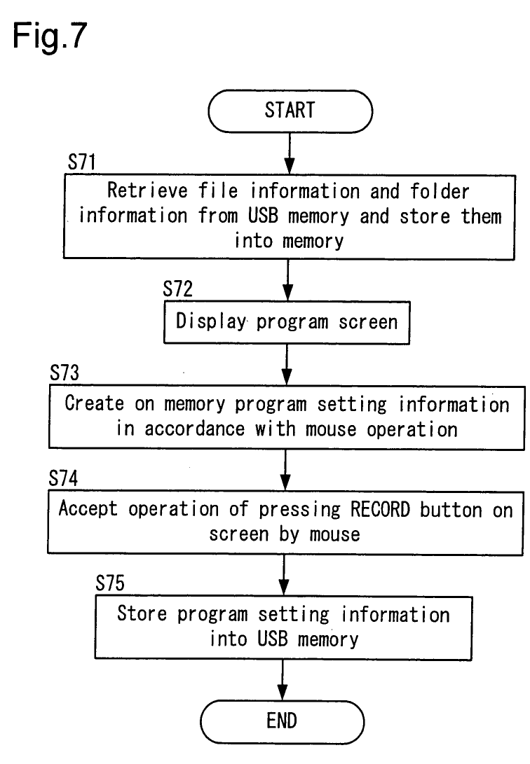

Upon start of retrieving a control program stored in the memory 12 by the controller 13 under the condition that a USB memory, not shown, storing files, file information, and folder information but not storing program setting information is attached to the USB interface 14, a flow shown in FIG. 7 starts.

In step S71, the controller 13 retrieves the file information and the folder information from the USB memory via the USB interface 14, and stores them into the memory 12. The file information and the folder information are same as those described above.

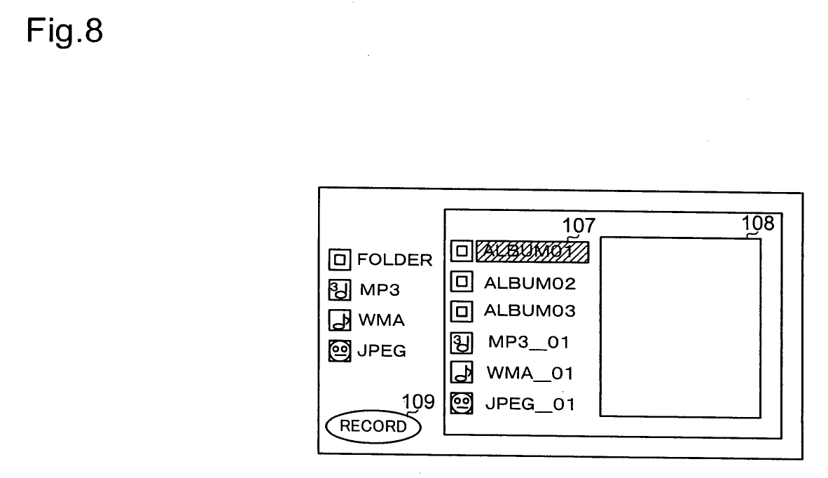

Then in step S72, the controller 13, based on the file information and folder information stored in the memory 12, generates a display signal and outputs it to the display device 15. Then, the display device 15 displays such a screen that includes a screen similar to the program screen displayed in step S28 of the flowchart shown in FIG. 2 and an additional button marked “RECORD”. FIG. 8 shows a display example. On this screen, the user can set file playback sequence.

Then in step S73, the operation proceeds to the operation in the flowchart shown in FIG. 4.

In step S41, the controller 13 substitutes 1 for the variable 1.

Here, a highlight 107 can be moved by click operation of the mouse device 11, and a file name can be selected by the highlight 107. When double click operation is performed with the mouse device 11 under the condition that a folder name of a folder located immediately below the root folder is selected by the highlight 107, file and folder names of a file and folder located immediately below the folder with the selected folder name are displayed, and also here, a file name can be selected by the highlight 107. Similarly, a file name of a file located immediately below a folder in any hierarchy can be selected by the highlight 107.

In step S42, double click operation is performed with the mouse device 11 under the condition that the file name is selected by the highlight 107 as described above, and the controller 13 receives an operation signal, and then the operation proceeds to step S43. In step S43, the controller 13 generates a display signal and outputs it to the display device 15, and the file name selected by the highlight 107 is displayed on a selected file display region 108 of the display device 15, with a corresponding mark provided at the head of this file name.

Then in step S44, the controller 13 stores the file position information and file name information corresponding to the file name selected by the highlight 107 into the memory 12 in correspondence with program number information indicating the variable I.

Subsequently, in step S45, the controller 13 increments the variable I by 1, and thereafter the same operation is repeated every time a file name is selected and determined in step S42.

Then when step S45 has been completed, a button 109 marked “RECORD” on the screen is pressed through click operation of the mouse device 11 (step S74 in FIG. 7), and then in step S75, the controller 13 stores, as program setting information, the program number information, file position information, and file name information, which have been stored into the memory 12 through the operation shown in FIG. 4, into the USB memory via the USB interface 14.

Upon attachment of the USB memory storing the program setting information in this manner to the USB interface loading type DVD player according to the invention described above, through the aforementioned processing of steps S21, 22, 23, 24, 25, 26, 27, and 32 of FIG. 2 in this order, the files stored in the USB memory are sequentially played back in the playback sequence set by the personal computer. Therefore, just one setting operation performed on the personal computer permits, in any USB interface loading type DVD player, subsequent playback of the files in the set playback sequence without requiring resetting operation, which is highly convenient.

What is claimed is:

1. A playback device comprising:
a USB interface;
an information creation section for creating, based on operation in an operation section, information indicating playback sequence for files stored in an external storage device connected to the USB interface; and
a storage section for storing the created information into the external storage device connected to the USB interface.

2. A playback device comprising:
a USB interface; and
a playback section for, based on information stored in an external storage device connected to the USB interface and indicating play back sequence for files stored in the external storage device, sequentially playing back the files.

3. The playback device according to claim 1, further comprising a playback section for, based on information stored in an external storage device connected to the USB interface and indicating the playback sequence for the files stored in the external storage device, sequentially playing back the files.

4. A computer program comprising a computer program code for causing a computer having an operation section and a USB interface to execute the steps of: creating, based on operation in the operation section, information indicating playback sequence for files stored in an external storage device connected to the USB interface; and storing the created information into the external storage device connected to the USB interface.
